(19) United States
(12) Patent Application Publication
(10) Pub. No.: US 2013/0070944 A1
(43) Pub. Date: Mar. 21, 2013

(54) Sound Bar Apparatus for Flat-panel Television

(71) Applicant: Ta-Ming LEE, Jian (CN)

(72) Inventor: Ta-Ming LEE, Jian (CN)

(73) Assignee: ACTION TECHNOLOGY (JIAN) CO., LTD.

(21) Appl. No.: 13/237,985

(22) Filed: Sep. 21, 2011

(51) Int. Cl. H04R 5/02

(52) U.S. Cl. 381/306

(57) ABSTRACT

A sound bar apparatus for a flat-panel television is disclosed. The sound bar apparatus for the flat-panel television includes a left loudspeaker box, a right loudspeaker box and a sound bar host. The left loudspeaker box includes left loudspeaker support plates, a plurality of loudspeakers located on the left loudspeaker support plates and connected with the sound bar host, a left transmission device and an up transmission device. The right loudspeaker box includes right loudspeaker support plates, a plurality of loudspeakers located on the right loudspeaker support plates and connected with the sound bar host, a right transmission device and an up transmission device. The sound bar apparatus of the present patent application can achieve better acoustics and improve the listening experience of the audiences when watching a big television screen at a long distance.

### FIELD OF THE PATENT APPLICATION

The present patent application relates generally to a sound bar apparatus of a television, and more particularly, to a sound bar apparatus for a flat-panel television.

### BACKGROUND

The flat-panel television has gradually taken the place of traditional television for the advantages of thin, light and high definition. The sound bar apparatus of the flat-panel television is generally located at the bottom of the television. The flat-panel television is light, thin and has small volume. If the screen of television is big, audiences have to watch the television from a long distance. When the volume of the sound bar is increased, the resonances with the television will be formed and the noise will be caused. This will influence the listening experience of the audiences.

### SUMMARY

A sound bar apparatus is provided to solve the above problems.

A sound bar apparatus for a flat-panel television is disclosed. The sound bar apparatus for the flat-panel television includes a left loudspeaker box, a right loudspeaker box and a sound bar host. The left loudspeaker box and the right loudspeaker box include loudspeaker support plates and a plurality of loudspeakers located on the loudspeaker support plates and connected with the sound bar host. The left loudspeaker box further includes a left transmission device and an up transmission device. The left transmission device is located at the left side of the left loudspeaker, the up transmission device is located among the plurality of loudspeakers and classifies the plurality of loudspeakers into movable parts and non-movable parts. The right loudspeaker box further includes a right transmission device and an up transmission device, the right transmission device is located at the right side of the right loudspeaker. The up transmission device is located among the plurality of loudspeakers and classifies the plurality of loudspeakers into movable parts and non-movable parts.

In an embodiment of the present patent application, the transmission devices include a plurality of gears which are hinged with each other.

In an embodiment of the present patent application, the left transmission device and the right transmission device include a plurality of vertical arranged gears which are hinged with each other. The up transmission device includes a plurality of parallel arranged gears which are hinged with each other.

In an embodiment of the present patent application, the left transmission device and the right transmission device comprise five vertical arranged gears which are hinged with each other, the up transmission device comprises two parallel arranged gears which are hinged with each other.

In an embodiment of the present patent application, the loudspeaker support plate of the left loudspeaker box includes a fixed part and a movable part which are movably linked by the left transmission device, a non-movable loudspeaker is located on the fixed part of the loudspeaker support plate and connected to the sound bar host, a movable loudspeaker and the up transmission device are located on the movable part of the loudspeaker support plate; the loudspeaker support plate of the right loudspeaker box includes a fixed part and a movable part which are movably linked by the right transmission device, a non-movable loudspeaker is located on the fixed part of the loudspeaker support plate and connected to the sound bar host, a movable loudspeaker and the up transmission device are located on the movable part of the loudspeaker support plate.

In an embodiment of the present patent application, the left loudspeaker box includes three loudspeakers, one of them is non-movable and connected to the sound bar host, two of them are movable with the rotation of the up transmission device; the right loudspeaker box includes three loudspeakers, one of them is non-movable and connected to the sound bar host, two of them are movable with the rotation of the up transmission device.

The sound bar apparatus of the present patent application can extend outside the television host and achieve better acoustics. The present patent application also improves the listening experience of the audiences when watching a big television screen at a long distance.

### BRIEF DESCRIPTION OF THE DRAWINGS

The present patent application will now be described in more detail with reference to specific embodiments thereof as shown in the appended drawings.

FIG. 1 illustrates the structure of a sound bar apparatus for a flat-panel television when the loudspeaker box is in the closed state.

FIG. 2 illustrates the structure of the sound bar apparatus for the flat-panel television when the loudspeaker box is in the first opened state.

FIG. 3 illustrates the structure of the sound bar apparatus for the flat-panel television when the loudspeaker box is in the second opened state.

### DETAILED DESCRIPTION

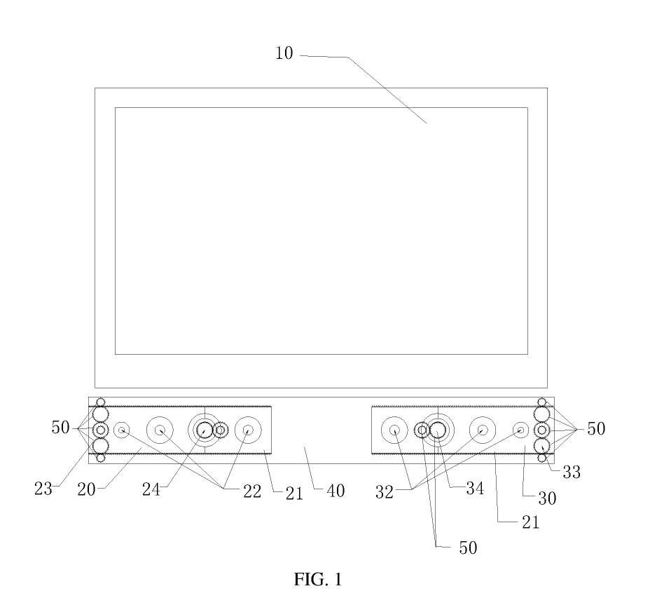

Referring to FIG. 1, a sound bar apparatus for a flat-panel television is connected with a television host 10. The sound bar apparatus includes a left loudspeaker box 20, a right loudspeaker box 30 and a sound bar host 40. The left loudspeaker box 20 includes a left loudspeaker support plate 21, three loudspeakers 22 set on the left loudspeaker support plate 21 and connected with the sound bar hostsound bar host 40, a left transmission device 23 and an up transmission device 24. The left transmission device 23 is located at the left side of the left loudspeaker support plate 21. The up transmission device 24 is located among the three loudspeakers and classifies the three loudspeakers into movable parts and non-movable parts. The loudspeaker support plate 21 of the left loudspeaker box includes two parts: a fixed part which is a fixed loudspeaker support plate 211 and a movable part which is a movable loudspeaker support plate 212. The fixed part and the movable part are movably linked by the left transmission device 23. A non-movable loudspeaker 221 is located on the fixed loudspeaker support plate 211. The non-movable loudspeaker 221 and the sound bar host 40 are connected to the fixed loudspeaker support plate 211. Two movable loudspeakers 222 and the up transmission device 24 are located on the movable loudspeaker support plate 212.

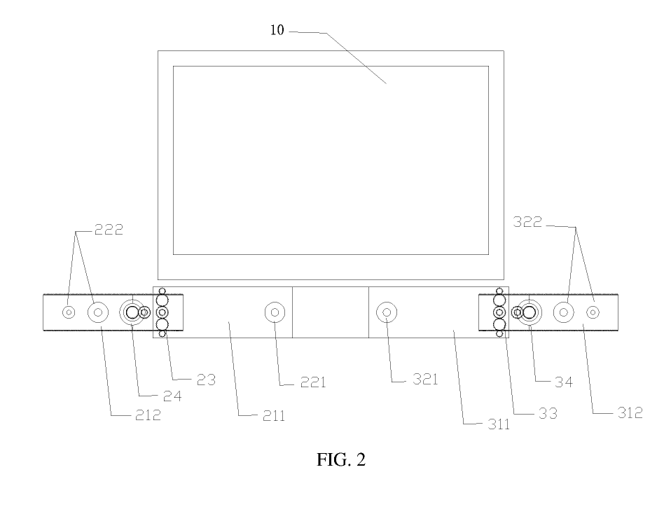

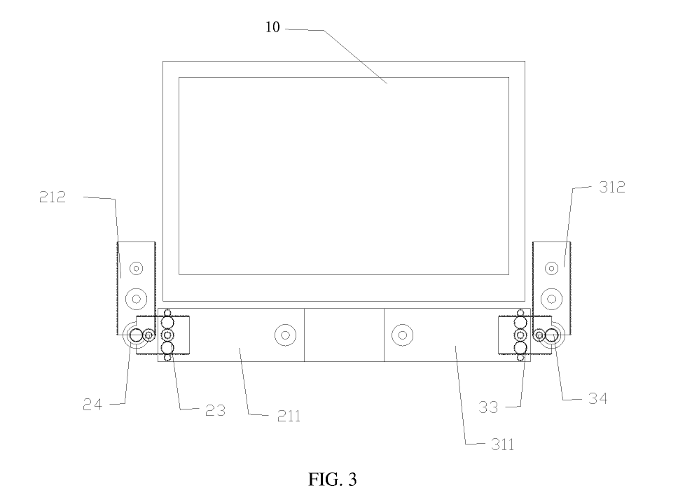

The left transmission device 23 includes five vertical arranged gears 50, which are hinged with each other. As shown in FIG. 2, when the gears rotate, they drag the movable loudspeaker support plate 212 to extend to the left. The up transmission device 24 includes two parallel arranged gears 50, which are hinged with each other. As shown in FIG. 3, when the gears rotate, they drag the movable loudspeaker support plate 212 to extend to the top.

The right loudspeaker box 30 includes a right loudspeaker support plate 31, three loudspeakers 32 set on the right loudspeaker support plate 31 and connected with the sound bar host 40, a right transmission device 33 and an up transmission device 34. The right transmission device 33 is located at the right side of the right loudspeaker support plate 31. The up transmission device 24 is located among the three loudspeakers and classifies the three loudspeakers into movable parts and non-movable parts. The loudspeaker support plate 31 of the right loudspeaker box includes two parts: a fixed part which is a fixed loudspeaker support plate 311 and a movable part which is a movable loudspeaker support plate 312. The fixed part and the movable part are movably linked by the right transmission device 33. A non-movable loudspeaker 321 is located on the fixed loudspeaker support plate 311. The non-movable loudspeaker 321 and the sound bar host 40 are connected to the fixed loudspeaker support plate 311. Two movable loudspeakers 322 and the up transmission device 34 are located on the movable loudspeaker support plate 312.

The right transmission device 33 includes five vertical arranged gears 50, which are hinged with each other. As shown in FIG. 2, when the gears rotate, they drag the movable loudspeaker support plate 312 to extend to the right. The up transmission device 34 includes two parallel arranged gears 50, which are hinged with each other. As shown in FIG. 3, when the gears rotate, they drag the movable loudspeaker support plate 312 to extend to the top.

The movable parts of the left loudspeaker box and the right loudspeaker box can extend to the left, the right and the top. Thus the loudspeaker boxes are located outside the television host. When the audiences need to increase the volume, a better acoustics can be achieved and the listening experience of the audiences can be improved.

While the present patent application is described above with reference to preferred embodiments, it should be understood that the present patent application is not limited thereto. Those of ordinary skill in the art having access to the teachings herein will recognize additional implementation and modifications, which are within the scope of the present patent application as disclosed and claimed herein.

What is claimed is:

1. A sound bar apparatus for a flat-panel television, comprising a left loudspeaker box, a right loudspeaker box and a sound bar host, the left loudspeaker box and the right loudspeaker box comprising loudspeaker support plates and a plurality of loudspeakers located on the loudspeaker support plates and connected with the sound bar host,
wherein the left loudspeaker box further comprises a left transmission device and an up transmission device, the left transmission device is located at the left side of the left loudspeaker, the up transmission device is located among the plurality of loudspeakers and classifies the plurality of loudspeakers into movable parts and non-movable parts; the right loudspeaker box further comprises a right transmission device and an up transmission device, the right transmission device is located at the right side of the right loudspeaker, the up transmission device is located among the plurality of loudspeakers and classifies the plurality of loudspeakers into movable parts and non-movable parts.

2. The sound bar apparatus for the flat-panel television in claim 1, wherein the transmission devices comprise a plurality of gears which are hinged with each other.

3. The sound bar apparatus for the flat-panel television in claim 2, wherein the left transmission device and the right transmission device comprise a plurality of vertical arranged gears which are hinged with each other, the up transmission device comprises a plurality of parallel arranged gears which are hinged with each other.

4. The sound bar apparatus for the flat-panel television in claim 3, wherein the left transmission device and the right transmission device comprise five vertical arranged gears which are hinged with each other, the up transmission device comprises two parallel arranged gears which are hinged with each other.

5. The sound bar apparatus for the flat-panel television in claim 1, wherein the loudspeaker support plate of the left loudspeaker box comprises a fixed part and a movable part which are movably linked by the left transmission device, a non-movable loudspeaker is located on the fixed part of the loudspeaker support plate and connected to the sound bar host, a movable loudspeaker and the up transmission device are located on the movable part of the loudspeaker support plate; the loudspeaker support plate of the right loudspeaker box comprises a fixed part and a movable part which are movably linked by the right transmission device, a non-movable loudspeaker is located on the fixed part of the loudspeaker support plate and connected to the sound bar host, a movable loudspeaker and the up transmission device are located on the movable part of the loudspeaker support plate.

6. The sound bar apparatus for the flat-panel television in claim 2, wherein the loudspeaker support plate of the left loudspeaker box comprises a fixed part and a movable part which are movably linked by the left transmission device, a non-movable loudspeaker is located on the fixed part of the loudspeaker support plate and connected to the sound bar host, a movable loudspeaker and the up transmission device are located on the movable part of the loudspeaker support plate; the loudspeaker support plate of the right loudspeaker box comprises a fixed part and a movable part which are movably linked by the right transmission device, a non-movable loudspeaker is located on the fixed part of the loudspeaker support plate and connected to the sound bar host, a movable loudspeaker and the up transmission device are located on the movable part of the loudspeaker support plate.

7. The sound bar apparatus for the flat-panel television in claim 3, wherein the loudspeaker support plate of the left loudspeaker box comprises a fixed part and a movable part which are movably linked by the left transmission device, a non-movable loudspeaker is located on the fixed part of the loudspeaker support plate and connected to the sound bar host, a movable loudspeaker and the up transmission device are located on the movable part of the loudspeaker support plate; the loudspeaker support plate of the right loudspeaker box comprises a fixed part and a movable part which are movably linked by the right transmission device, a non-movable loudspeaker is located on the fixed part of the loudspeaker support plate and connected to the sound bar host, a movable loudspeaker and the up transmission device are located on the movable part of the loudspeaker support plate.

8. The sound bar apparatus for the flat-panel television in claim 4, wherein the loudspeaker support plate of the left loudspeaker box comprises a fixed part and a movable part which are movably linked by the left transmission device, a non-movable loudspeaker is located on the fixed part of the loudspeaker support plate and connected to the sound bar host, a movable loudspeaker and the up transmission device are located on the movable part of the loudspeaker support plate; the loudspeaker support plate of the right loudspeaker box comprises a fixed part and a movable part which are movably linked by the right transmission device, a non-movable loudspeaker is located on the fixed part of the loudspeaker support plate and connected to the sound bar host, a movable loudspeaker and the up transmission device are located on the movable part of the loudspeaker support plate.

9. The sound bar apparatus for the flat-panel television in claim 5, wherein the left loudspeaker box comprises three loudspeakers, one of them is non-movable and connected to the sound bar host, two of them are movable with the rotation of the up transmission device; the right loudspeaker box comprises three loudspeakers, one of them is non-movable and connected to the sound bar host, two of them are movable with the rotation of the up transmission device.

10. The sound bar apparatus for the flat-panel television in claim 6, wherein the left loudspeaker box comprises three loudspeakers, one of them is non-movable and connected to the sound bar host, two of them are movable with the rotation of the up transmission device; the right loudspeaker box comprises three loudspeakers, one of them is non-movable and connected to the sound bar host, two of them are movable with the rotation of the up transmission device.

11. The sound bar apparatus for the flat-panel television in claim 7, wherein the left loudspeaker box comprises three loudspeakers, one of them is non-movable and connected to the sound bar host, two of them are movable with the rotation of the up transmission device; the right loudspeaker box comprises three loudspeakers, one of them is non-movable and connected to the sound bar host, two of them are movable with the rotation of the up transmission device.

12. The sound bar apparatus for the flat-panel television in claim 8, wherein the left loudspeaker box comprises three loudspeakers, one of them is non-movable and connected to the sound bar host, two of them are movable with the rotation of the up transmission device; the right loudspeaker box comprises three loudspeakers, one of them is non-movable and connected to the sound bar host, two of them are movable with the rotation of the up transmission device.
